(19) United States
(12) Patent Application Publication
(10) Pub. No.: US 2022/0040975 A1
(43) Pub. Date: Feb. 10, 2022

(54) FIRE PULSE CONTROL CIRCUIT HAVING PULSE WIDTH ADJUSTMENT RANGE

(71) Applicant: Hewlett-Packard Development Company, L.P., Spring, TX (US)

(72) Inventors: Daryl E Anderson, Corvallis, OR (US); Eric Martin, Corvallis, OR (US)

(73) Assignee: Hewlett-Packard Development Company, L.P., Spring, TX (US)

(21) Appl. No.: 17/311,565

(22) PCT Filed: Apr. 30, 2019
(86) PCT No.: PCT/US2019/030058

§ 371 Date: Jun. 7, 2021

(51) Int. Cl. B41J 2/045

(52) U.S. Cl. CPC B41J 2/04591; B41J 2/04598; B41J 2/0458; B41J 2/04543; B41J 2/04563; B41J 2/04541

(57) ABSTRACT

A fire pulse control circuit for a fluidic die includes input logic to receive a series of zone temperatures, each corresponding to a different zone of the fluidic die, each zone having a corresponding fire pulse having a width corresponding to a pulse temperature, the width adjustable from a minimum width corresponding to a maximum pulse temperature to a maximum width corresponding to a minimum pulse temperature. For each zone temperature, adjustment logic outputs a zone adjustment signal to decrease the fire pulse width of the corresponding zone if the zone temperature is greater than the pulse temperature and the pulse temperature is less than the maximum pulse temperature, and outputs a zone adjustment signal to increase the fire pulse width of the corresponding zone if the zone temperature is less than the pulse temperature and the pulse temperature is greater than the minimum pulse temperature.

### BACKGROUND

Some print components may include an array of nozzles and/or pumps each including a fluid chamber and a fluid actuator, where the fluid actuator may be actuated to cause displacement of fluid within the chamber. Some example fluidic dies may be printheads, where the fluid may correspond to ink or print agents. Print components include printheads for 2D and 3D printing systems and/or other high-pressure fluid dispensing systems.

### BRIEF DESCRIPTION OF THE DRAWINGS

FIG. 1 is a block and schematic diagram generally illustrating a fire pulse control circuit for a fluidic die, according to one example.

FIG. 2, is a block and schematic diagram generally illustrating a fluidic die employing a down-delay zonal fire signal adjustment arrangement and including fire pulse control circuitry, according to one example.

FIG. 3 generally illustrates an example of a fire pulse signal, according to one example.

FIG. 4 is graph generally illustrating a relationship between a temperature of the fluidic die and a fire pulse width, according to one example.

FIG. 5 is a pulse width versus temperature curve, according to one example.

FIG. 6 is a block and schematic diagram generally illustrating a fire pulse adjustment circuit having a down-delay zonal fire signal adjustment arrangement, according to one example

FIG. 7 is a block and schematic diagram generally illustrating a fire pulse control circuit, according to one example.

FIG. 8 is a table of values, including a series of zone temperature values, illustrating the operation of a pulse width control circuit, according to one example.

FIG. 9 is a flow diagram illustrating a method of adjusting a pulse width for a fluidic die, according to one example.

FIG. 10 is a flow diagram describing a method of controlling a fire pulse for a fluidic die, according to one example.

FIG. 11 is a schematic diagram illustrating a block diagram illustrating one example of a fluid ejection system.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Examples of print components, such as fluidic dies, for instance, may include fluid actuators. The fluid actuators may include thermal resistor-based actuators (e.g., for firing or recirculating fluid), piezoelectric membrane based actuators, electrostatic membrane actuators, mechanical/impact driven membrane actuators, magneto-strictive drive actuators, or other suitable devices that may cause displacement of fluid in response to electrical actuation. Fluidic dies described herein may include a plurality of fluid actuators, which may be referred to as an array of fluid actuators. An actuation event may refer to singular or concurrent actuation of fluid actuators of the fluidic die to cause fluid displacement. An example of an actuation event is a fluid firing event whereby fluid is jetted through a nozzle orifice.

Example fluidic dies may include fluid chambers, orifices, fluidic channels, and/or other features which may be defined by surfaces fabricated in a substrate of the fluidic die by etching, microfabrication (e.g., photolithography), micromachining processes, or other suitable processes or combinations thereof. In some examples, fluidic channels may be microfluidic channels where, as used herein, a microfluidic channel may correspond to a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.). Some example substrates may include silicon-based substrates, glass-based substrates, gallium arsenide based-substrates, and/or other such suitable types of substrates for microfabricated devices and structures.

In example fluidic dies, a fluid actuator (e.g., a thermal resistor) may be implemented as part of a fluidic actuating structure, where such fluidic actuating structures include nozzle structures (sometimes referred to simply as “nozzles”) and pump structures (sometimes referred to simply as “pumps”). When implemented as part of a nozzle structure, in addition to the fluid actuator, the nozzle structure includes a fluid chamber to hold fluid, and a nozzle orifice in fluidic communication with the fluid chamber. The fluid actuator is positioned relative to the fluid chamber such that actuation (e.g., firing) of the fluid actuator causes displacement of fluid within the fluid chamber which may cause ejection of a fluid drop from the fluid chamber via the nozzle orifice. In one example nozzle, the fluid actuator comprises a thermal actuator, where actuation of the fluid actuator (sometimes referred to as “firing”) heats fluid within the corresponding fluid chamber to form a gaseous drive bubble that may cause a fluid drop to be ejected from the nozzle orifice.

When implemented as part of a pump structure, in addition to the fluid actuator, the pump structure includes a fluidic channel. The fluid actuator is positioned relative to a fluidic channel such that actuation of the fluid actuator generates fluid displacement in the fluid channel (e.g., a microfluidic channel) to thereby convey fluid within the fluidic die, such as between a fluid supply and a nozzle structure, for instance.

As described above, fluid actuators, and thus, the corresponding fluidic actuator structures, may be arranged in arrays (e.g., columns), where selective operation of fluid actuators of nozzle structures may cause ejection of fluid drops, and selective operation of fluid actuators of pump structures may cause conveyance of fluid within the fluidic die. In some examples, the array of fluidic actuating structures may be arranged in sets of fluidic actuating structures, where each such set of fluidic actuating structures may be referred to as a “primitive” or a “firing primitive.” The number of fluidic actuating structures, and thus, the number of fluid actuators in a primitive, may be referred to as a size of the primitive.

In some examples, the set of fluidic actuating structures of each primitive are addressable using a same set of actuation addresses, with each fluidic actuating structure of a primitive and, thus, the corresponding fluid actuator, corresponding to a different actuation address of the set of actuation addresses. In examples, the address data representing the set of actuation addresses are communicated to each primitive via an address bus shared by each primitive. In some examples, in addition to the address bus, fire pulse lines communicate one or more fire pulse signals to each primitive, and each primitive receives actuation data (sometimes referred to as fire data, nozzle data, or primitive data) via a corresponding data line.

In some cases, electrical and fluidic operating constraints of a fluidic die may limit which fluid actuators of each primitive may be actuated concurrently for a given actuation event. Arranging the fluid actuators and, thus, the fluid actuating structures, into primitives facilitates addressing and subsequent actuation of subsets of fluid actuators that may be concurrently actuated for a given actuation event in order to conform to such operating constraints.

To illustrate by way of example, if a fluidic die comprises four primitives, with each primitive including eight fluid actuating structures (with each fluid actuator structure corresponding to different address of a set of addresses 0 to 7), and where electrical and/or fluidic constraints limit actuation to one fluid actuator per primitive, the fluid actuators of a total of four fluid actuating structures (one from each primitive) may be concurrently actuated for a given actuation event. For example, for a first actuation event, the respective fluid actuator of each primitive corresponding to address “0” may be actuated. For a second actuation event, the respective fluid actuator of each primitive corresponding to address “5” may be actuated. As will be appreciated, such example is provided merely for illustration purposes, with fluidic dies contemplated herein may comprise more or fewer fluid actuators per primitive and more or fewer primitives per die.

In some examples, during an actuation or firing event, for each primitive, based on actuation data for the primitive communicated via its corresponding data line, the fluidic actuator corresponding to the address on the address bus will actuate (e.g., “fire”) in response to the fire pulse, where an amount of energy provided to the fluidic actuator depends, in part, on a width of the fire pulse (i.e., the greater the fire pulse width, the greater the amount of energy delivered to the fluidic actuator). In some cases, a width of a fire pulse is selected which provides an amount of energy to a fluidic actuator to cause ejection of a fluid drop having an optimal drop weight when the fluidic die is operating at a design temperature (e.g., 55 degrees Celsius).

However, heat generated during operation of the fluidic die may be absorbed by the substrate and other components and result in a thermal gradient across the fluidic die. In some cases, localized thermal gradients of 15 degrees ° C., or more, may exist across a fluidic die. Because the relationship between fluid drop weight and fire pulse energy changes with temperature, such variation of the operating temperature from the design temperature may affect the ejection of fluid from nozzle structures. For example, similar fluidic actuating structures at different operating temperatures will generate fluid drops having different weights in response to a same fire pulse. As such, variations in operating temperature from a design temperature across a fluidic day may result in an undesirable variance is weight of ejected fluid drops.

In some fluidic dies, fluidic actuating structures are arranged in columns on the fluidic die, with the fluidic actuating structures of each column organized to form a series of primitives. During operation, thermal gradients tend to arise across a length of the columns, with operating temperatures increasing from the ends of the columns toward the middle. As a consequence, in response to a same fire pulse, fluidic actuating structures of primitives in middle portions of the columns may eject fluid drops of a greater drop weight than fluidic actuating structures of primitives nearer to the ends of the columns.

To compensate for such thermal gradients, some fluidic dies employ a zonal firing signal adjustment technique where each column of fluidic actuating structures is divided into a series of zones, with each zone including a number of primitives and having a corresponding thermal sensor (e.g., a thermal diode), with each zone having a corresponding fire pulse to be applied to the fluid actuating structures of the corresponding primitives. According to examples, an operating temperature of each zone is measured and a width of the fire pulse is adjusted based on the measured temperature. By adjusting the width of the fire pulse for each zone to compensate for the zone temperature, drop weight variations between zones are reduced.

According to one zonal firing signal adjustment technique, sometimes referred to as a “down-delay” technique, beginning at a first zone (e.g., at a top of a column), an input fire pulse (or firing signal) successively propagates through each zone of the column, with the fire pulse being delayed each time it passes from one primitive, or group of primitives, to another such that a limited number of primitives of the column are being fired at a given time. Firing one primitive at a time prevents the fluidic die from exceeding electrical and fluidic operating constraints.

In addition to delaying the fire pulse, as the fire pulse propagates through the column, for each zone, the zonal firing adjustment technique adjusts the width of the width of the fire pulse received from the previous zone based on the temperature of the zone. Adjusting the pulse width from zone to zone compensates for temperature variations between zones and thereby lessens variations in drop weights from zone to zone due to thermal gradients. In some examples, as will be described in greater detail below, adjustments to the pulse width are made in time increments or quanta, each increment or quanta being a same time duration. In one example, an initial width of the input fire pulse received by the first zone is based on the temperature of the first zone.

While zonal firing signal adjustment techniques reduce variations in drop weights between zones, as a fire pulse propagates down the column, zone-to-zone adjustments to the width of fire pulse may accumulate such that the pulse width may become too wide or too narrow. If the pulse width is too wide, an excessive amount energy may be delivered to the fluidic actuator, which is inefficient and may damage the fluid actuator. If the pulse is too narrow, an amount of energy delivered to the fluid actuator may be insufficient to effectuate ejection of a fluid drop.

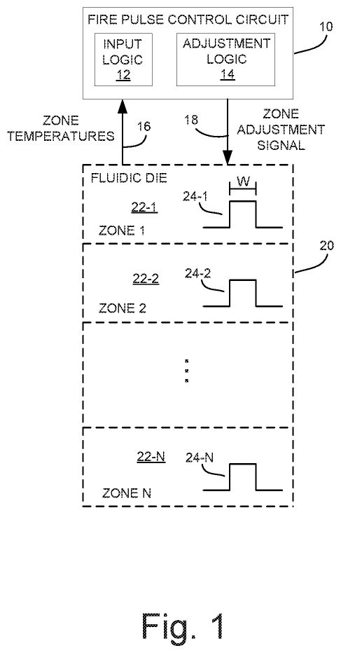

FIG. 1 is a block and schematic diagram generally illustrating a fire pulse control circuit 10 for a fluidic die 20, according to one example of the present disclosure, which limits adjustment of a fire pulse width, such as with a down-delay arrangement, for instance, to a pulse width range which ensures that an adjusted fire pulse delivers an effective amount of energy to a fluidic actuator. Although illustrated as being off fluidic die 20 in FIG. 1, in other examples, fire pulse control circuit 10 may be disposed on fluidic die 20.

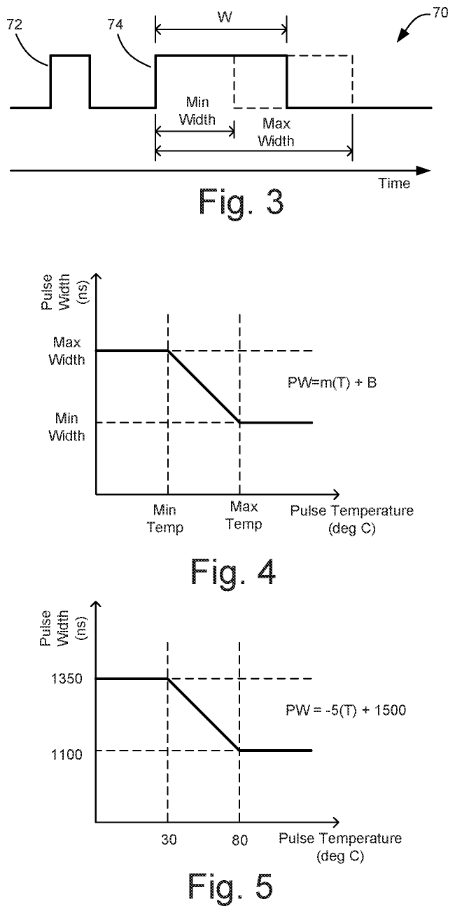

In one example, fire pulse control circuit 10 includes input logic 12 and adjustment logic 14. Fluidic die 20 is divided into a number of zones, illustrated as zones 22-1 to 22-N, with each zone 22 having a corresponding fire pulse, illustrated as fire pulses 24-1 to 24-n, for controlling actuation of fluidic actuators in each zone. As will be described in greater detail below (e.g., FIGS. 3 & 4), a width, W, of each fire pulse 24 has a width, W, has a corresponding temperature, where such corresponding temperature is referred to herein as a “pulse temperature”. According to principles of the present disclosure, the pulse width is adjustable within pulse width adjustment range from a minimum width to a maximum width, where the minimum width corresponds to a maximum pulse temperature, and the maximum width corresponds to a minimum pulse temperature.

In one example, input logic receives via a signal line 16 a series of zone temperatures, each zone temperature corresponding to a different one of the zones 22 of fluidic die 20. In one example, the series of zone temperatures is in order from zone 22-1 to zone 22-N. In one case, for each zone temperature, adjustment logic 14 outputs a zone adjustment signal via a signal line 18 to direct a decrease in the width, W, of the fire pulse 24 of the corresponding zone 22 if the zone temperature is greater than the pulse temperature and the pulse temperature is less than the maximum temperature, where, as described above, the pulse temperature corresponds to the width of the pulse. For each zone temperature, adjustment logic 14 outputs a zone adjustment signal 18 via signal line 18 to direct an increase in the width, W, of the fire pulse 24 of the corresponding zone 22 if the zone temperature is less than the pulse temperature and the pulse temperature is greater than the minimum pulse temperature.

In one example, for each zone temperature, adjustment logic 14 outputs a zone adjust signal directing no change in the width of the fire pulse 24 of the corresponding zone 22 if the current pulse temperature is greater than the zone temperature and not greater than the minimum pulse temperature, or if the current pulse temperature is less than the zone temperature and not less than the maximum pulse temperature, or if the current pulse temperature is equal to the zone temperature.

By limiting adjustments to the width of the fire pulse signal 24 of each zone 22 of fluidic die 20 to be within a minimum-to-maximum pulse width range (which corresponds to a maximum-to-minimum pulse temperature range), fire pulse control circuit 10 provides adjustments to fire pulse signals that reduce variations in drop weights between zones while ensuring that an adjusted fire pulse delivers an effective amount of energy to fluidic actuators of fluidic die 20.

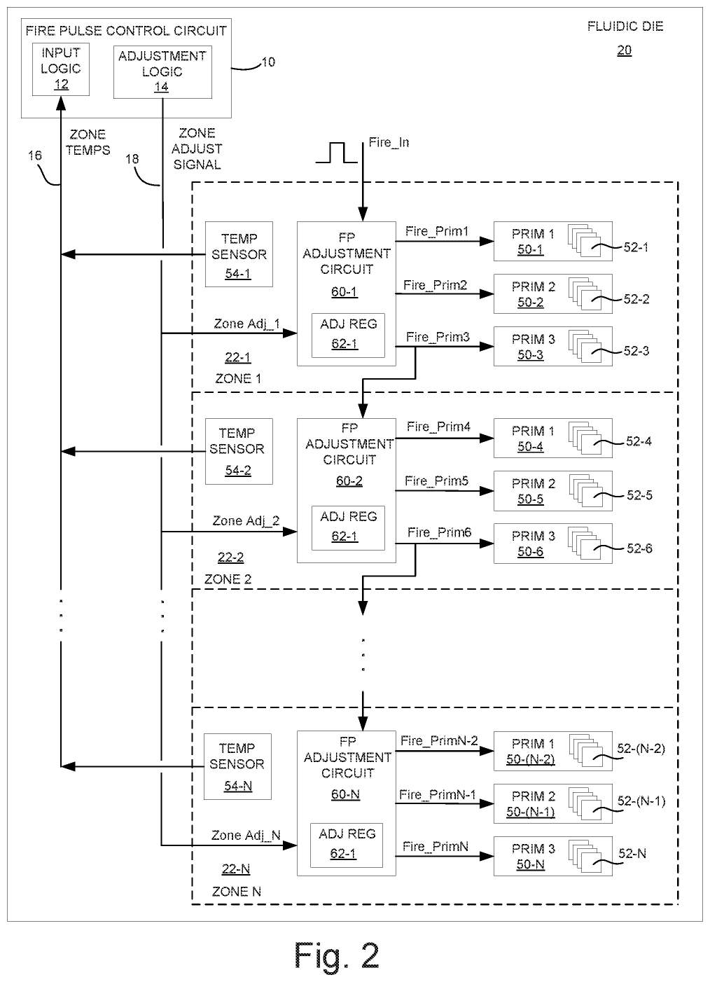

FIG. 2 is a block and schematic diagram generally illustrating fluidic die 20 employing a down-delay zonal fire signal adjustment arrangement and including fire pulse control circuitry 10, according to one example. As illustrated, each zone 22 includes a number of primitives 50, with each primitive 50 including a number of fluid actuating devices 52. For ease of illustration, while each zone 22 is illustrated as having three primitives 50 (e.g., zone 1 includes primitives 50-1 to 50-3 respectively including pluralities of fluid actuators 52-1 to 52-3), zones 22 may include any number of primitives 50. Additionally, each zone 22 includes a thermal sensor 54 and a fire pulse adjustment circuit 60, with fire pulse adjustment circuit 60 including an adjustment register 62 to store a zone adjustment value, the zone adjustment value indicative of a time duration by which fire pulse adjustment circuit 60 is to adjust a width of the fire pulse of the corresponding zone. In one example, each fire pulse adjustment circuit 60 adjusts a width of the fire pulse for the corresponding zone based on the zone adjustment value stored in adjustment register 62 to provide an adjusted fire pulse for the corresponding primitives 50 and, additionally, delays the propagation of the adjusted fire pulse through the zone at each primitive 50.

An example of the operation of fluidic die 20 of FIG. 2 is described below with additional reference to FIGS. 3 and 4. FIG. 3 generally illustrates an example of a fire pulse or fire signal 70. In the illustrated example, fire signal 70 includes multiple pulses, a precursor pulse (PCP) 72, and a fire pulse (FP) 74, where the PCP 72 may serve to preheat fluid within a fluidic actuating structure, and the FP 74 serves to energize a fluid actuator to cause ejection of a fluid drop. As illustrated, FP 74 has a width, W, where adjusting the width controls an amount of energy delivered to a fluid actuator by fire signal 70. The greater the width, the greater the energy delivered. In one example, as described above, the width of FP 74 is adjusted in a range from a minimum pulse width to a maximum pulse width, where the minimum and maximum pulse widths respectively corresponding to the minimum and maximum energy to be delivered to a fluid actuator by FP 74.

As described above, a temperature of a fluidic die proximate to the location of a fluidic actuator impacts the amount energy that should be delivered by a fire pulse to provide effective actuation of the fluid actuator to produce a fluid drop having desired characteristics. FIG. 4 is graph generally illustrating a relationship between the temperature of the fluidic die and a fire pulse width for delivering an optimal amount of energy to a fluid actuator for fluid drop ejection. The die temperature is represented by the x-axis, while the pulse width is represented by the y-axis, with the minimum pulse width corresponding to the maximum temperature and the maximum pulse width corresponding to the minimum temperature.

In one example, as illustrated, the relationship between the pulse width (PW) and temperature (T) within the adjustment range is characterized by the equation PW=m(T)+B, where m is the slope and B is an offset value. As described above, in one example, fire pulse controller 10 limits pulse width adjustments to the range defined by the minimum and maximum pulse widths. A width at which a fire pulse is set has a corresponding temperature is referred to as the “pulse temperature” of the fire pulse. For example, with reference to FIG. 4, if the pulse width is at the maximum width, the pulse temperature of the fire pulse corresponds to the minimum temperature.

As will be described in greater detail below, in one example, FP adjustment circuits 60 adjust the pulse widths in fixed increments, sometimes referred to herein as “quanta”, where adjusting a pulse width by a quanta (e.g., a certain number of nanoseconds) results in a change corresponding change in the pulse temperature of the adjusted fire pulse. In other examples, in lieu of adjusting the pulse width in fixed increments, the pulse width may be continually adjusted over the pulse width adjustment range, such as based on the above described relationship between pulse width and temperature.

FIG. 5 is a pulse width versus temperature curve for an example fluidic die where the pulse width ranges from a minimum of 1100 ns to a maximum of 1350 ns, with the minimum and maximum pulse widths respectively corresponding to temperatures of 80° C. and 30° C. According to such example, the pulse width equation in the pulse width adjustment range for such curve is PW=−5(T)+1500. According to one example, if fire pulse adjustment circuit 60 is configured to adjust the pulse width in 5 ns increments, the 250 ns fire pulse width adjustment range is divided into 50 increments, with each 5 ns increment (or quanta) corresponding to a 1 degree change in temperature.

Returning to FIG. 2, according to one example, during operation, fire pulse control circuit 10, via input logic 12, periodically (e.g., every 500 microseconds or other interval) receives a series of zone temperatures from temperature sensors 54-1 to 54-N via signal path 16, with each zone temperature corresponding to a different zone 22. In one example, the series of zone temperature are received in the order in which the fire pulse propagates through the zones (e.g., zone 1 to zone N in FIG. 2). In one example, for each zone temperature, adjustment logic 14 outputs a zone adjustment signal representing a zone adjustment value to the zone adjustment register 62 via signal line 18, as indicated by zone adjustment signals Zone Adj_1 to Zone Adj_N, where the zone adjustment value is indicative of a time duration by which fire pulse adjustment circuit 60 is to adjust a width of the fire pulse of the corresponding zone. As described below, each FP adjustment circuit 60 adjusts the width of the fire pulse for the corresponding zone based on the adjustment value in the corresponding adjustment register 62. In one example, the zone adjustment value indicates a number of increments, or quanta, by which the fire pulse width is to be adjusted.

In one example, for each zone temperature, adjustment logic 14 outputs a zone adjustment signal having an adjustment value directing a decrease of the fire pulse width for the corresponding zone 22 if the zone temperature is greater than the pulse temperature corresponding to the current pulse width, and the pulse temperature is less than the maximum pulse temperature. It is noted that by decreasing the fire pulse width, the pulse temperature of the fire pulse, which corresponds to the pulse width, increases by an amount corresponding to the decrease in pulse width (e.g., see FIGS. 4 & 5). In one example, the current pulse temperature for a zone is the pulse temperature corresponding to the pulse width of the fire pulse of the preceding zone. In one example, since no zone precedes first zone 22-1, the pulse width and corresponding current pulse temperature of zone 1 corresponds to the zone temperature as measured by thermal sensor 54-1.

In one example, for each zone temperature, adjustment logic 14 outputs a zone adjustment signal having an adjustment value directing an increase of the fire pulse width for the corresponding zone 22 if the zone temperature is less than the current pulse temperature, and the current pulse temperature of the fire pulse is greater than the minimum pulse temperature (e.g., 30 C in FIG. 5). It is noted that increasing the fire pulse width results in a decrease of the corresponding pulse temperature of the fire pulse.

In one example, adjustment logic 14 outputs a zone adjustment signal having an adjustment value directing no change in the fire pulse width if the zone temperature is less than the pulse temperature and the pulse temperature is not greater than the minimum pulse temperature, or the zone temperature is greater than the pulse temperature and the pulse temperature is not less than the maximum pulse temperature; or the zone temperature is equal to the pulse temperature.

Each time a series of zone temperatures is processed by fire pulse control circuit 10, adjustment logic 14 outputs an updated zone adjustment value to zone adjustment register 62 of each zone 22. In one example, the processing of zone temperature values by fire pulse control circuit 10 is performed asynchronously to firing operations of the fluid actuating devices 52 of primitives 50.

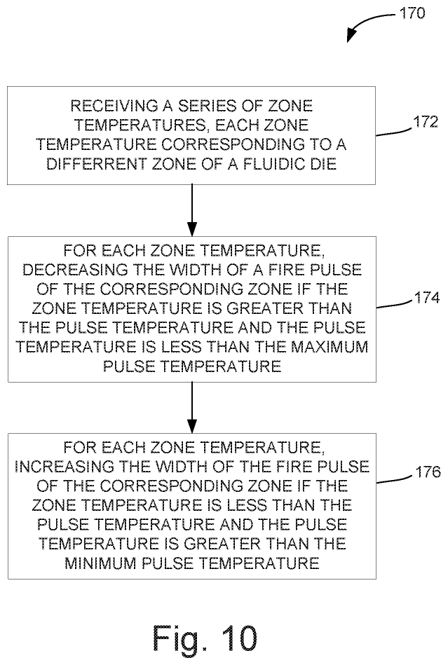

Continuing with FIG. 2, according to one example, during a firing operation of fluidic actuating devices 52 of primitives 50 of each zone 22, first zone 22-1 receives an input fire signal, indicated as Fire_In, such as from a system controller (e.g., see electronic controller 230 of FIG. 10). In one example, as described above, the pulse width and, thus, the corresponding pulse temperature of the input fire pulse, Fire_In, is based on the most recent temperature measurement of zone 22-1. As the fire pulse propagates through the remaining zones 22-2 through 22-N, each of the zones receives as its input fire pulse signal the adjusted fire pulse from the preceding zone, such as zone 22-2 receiving Fire_Prim3 from zone 1 as its input fire pulse signal.

In one example, for each zone 22, as the incoming fire pulse signal is received from the previous zone (or Fire_In in the case of zone 22-1), FP adjustment circuit 60 adjusts the width of the fire pulse based on the adjustment value stored in adjustment register 62, where FP adjustment circuit 60 may increase, decrease, or leave the pulse width unchanged. In one example, FP adjustment circuit 60 provides the adjusted fire pulse signal to each primitive 50, successively delaying the signal as it passes from one primitive to the next.

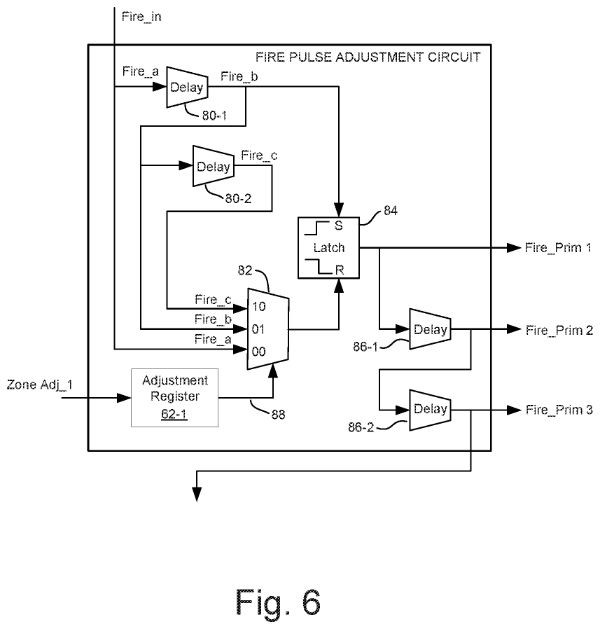

FIG. 6 is a block and schematic diagram generally illustrating a FP adjustment circuit 60 having a down-delay zonal fire signal adjustment arrangement, according to one example, which is illustrated in terms of FP adjustment circuit 60-1 of FIG. 2. FP adjustment circuit 60-1, in addition to zone adjustment register 62-1, includes delay elements 80-1 and 80-2, a multiplexer 82, a latch 84, and delay elements 86-1 and 86-2. Delay elements 86-1 and 86-2 each provide a delay equal to a quanta by which the fire pulse width may be increased or decreased. For example, with reference to the example described above with respect to FIG. 5, if the increment quanta is 5 ns, delay elements 86-1 and 86-2 each provide a 5 ns delay.

In operation, incoming fire pulse signal Fire_in, also labeled as Fire_a, is delayed by delay element 86-1 to provide fire pulse signal Fire_b, which, in-turn, is delayed by delay element 80-2 to provide fire pulse signal Fire_c. Fire pulse signals Fire_a, Fire_b, and Fire_c are inputs to multiplexer 82, with the output of adjust register 62-1 and, thus, the adjust value stored therein, serving as the selector signal of multiplexer 82 to select the output signal 88 thereof. Fire_b and output signal 88 of multiplexer 82 respectively serve as the S and R inputs to RS Latch 84. The output of latch 84 serves as the fire signal, Fire_Prim1, for primitive 52-1, with Fire_Prim1 being delayed by delay element 86-1 to provide Fire_Prim2 for primitive 52-2, and Fire_Prim2 being delayed by delay element 86-2 to provide Fire_Prim3 for primitive 52-3. The fire signal for the last primitive of the zone, in this case, Fire_Prim3, serves as the input fire signal for the next zone.

According to the illustrated example, the rising edge of Fire_b at input S of RS latch 84 triggers the rising edge of the fire pulse of Fire_Prim1, and the adjustment value of adjustment register 62-1, at 88, selects the input to multiplexer 82 which triggers the falling edge of the Fire_Prim1. In the illustrated example, if the adjust value in adjust register 62-1 has a value of “00”, Fire_a serves as the R input to RS latch 84 such that the pulse width of Fire_Prim1 is equal to the pulse width of Fire_in as decremented by the adjustment quanta (i.e., the pulse width is decreased by the adjustment quanta).

If the adjust value in adjust register 62-1 has a value of “10”, Fire_c serves as the R input to RS latch 84 such that the pulse width of Fire_Prim1 is equal to the pulse width of Fire_in as incremented the same delay quanta as that of delay elements 80-1 and 80-2 (i.e., the pulse width is increased). If the adjust value in register 62-1 has a value of “01’, Fire_b serves as the R input to RS latch 84 such that pulse of Fire_Prim 1 is equal to the pulse width of Fire-in (i.e., the pulse width is not adjusted).

It is noted that the fire pulse adjustment circuit 60 of FIG. 6 is configured to adjust the fire pulse width by increments of +/−1 adjustment quanta. In other examples, fire pulse adjustment circuit 60 may be configured to adjust the fire pulse width in increments other than +/−1 quanta, such +/−2, +/−3 quanta, and so on, with the inclusion of additional delay elements 80. For example, 4 delay elements 80 would be needed for +/−2 quanta of adjustment, and 6 delay elements would be needed for +/−3 quanta of adjustment, and so on.

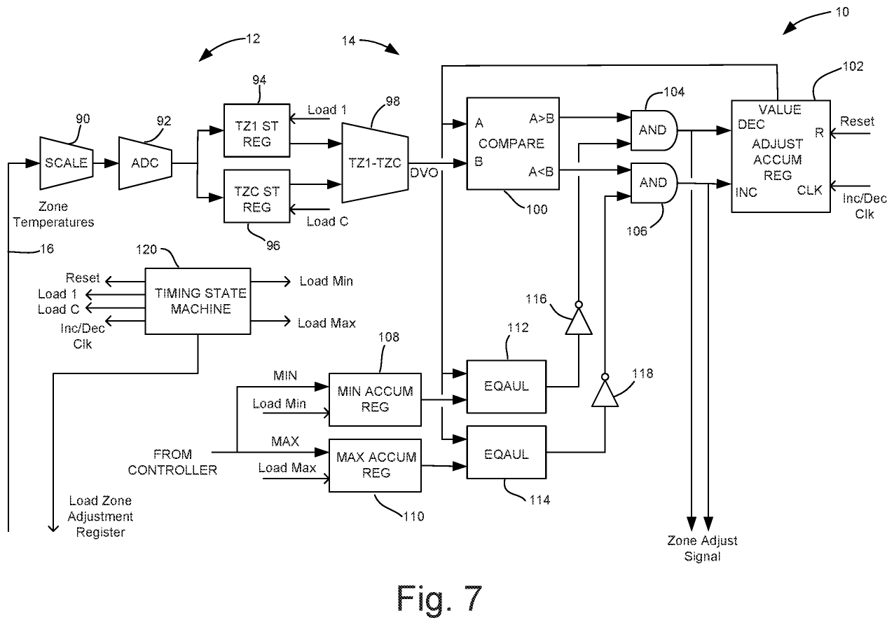

FIG. 7 is a block and schematic diagram generally illustrating fire pulse control circuit 10, including input logic 12 and adjustment logic 14, according to one example. It is noted that adjustment logic 14 of FIG. 7 is configured for use with a fire pulse adjustment circuit 60 having +/−1 quanta of pulse width adjustment. In one example, input logic 12 includes a scaling block 90, an analog-to digital converter (ADC) 92, and registers 94 and 96. In one example, scaling block 90 and ADC 92, together, receive and convert the series of analog zone temperatures received via signal line 16 from temperature sensors 54 to digital values representative of a number of adjustment quanta. For example, in a case where it has been determined that one quanta of pulse width adjustment should be made for every 2.5° C. of zone temperature change, a zone temperature of 60° C. may be converted to a value of 138, whereas a zone temperature of 62.5° C. may be converted to a value of 139. This scaled and converted temperature value is sometime referred to herein as a “synthetic” temperature (ST).

For the initial zone temperature of the series of zone temperature corresponding to first zone 22-1, the synthetic temperature is loaded into both register 94 (which stores the synthetic temperature of the initial zone) and in register 96 (which stores the synthetic value of the current zone temperature of the series of zone temperatures received by input logic 12. The synthetic temperature of each subsequent zone temperature of the series of zone temperatures is successively loaded into register 96.

For each zone temperature, subtract element 98 subtracts the current zone temperature stored in register 96 from the temperature of the initial or first zone 22-1 and output the difference, DVO, to a first input (input B) of comparator block 100. An adjustment accumulation register 102 holds a running total of the accumulated pulse width adjustments made by adjust adjustment logic 14, and provides the accumulated adjustment value to a second input (input A) of comparator block 100. As illustrated, comparator block 100 compares the accumulated adjustment value to the difference, DVO. If the accumulated adjustment value is greater than DV0, comparator block 100 outputs a logic high (e.g., “1”) to a first input of a decrement AND-gate 104. If the accumulated adjustment value is less than DV0, comparator block 100 outputs a logic high (e.g., “1”) to a first input of an increment AND-gate 106.

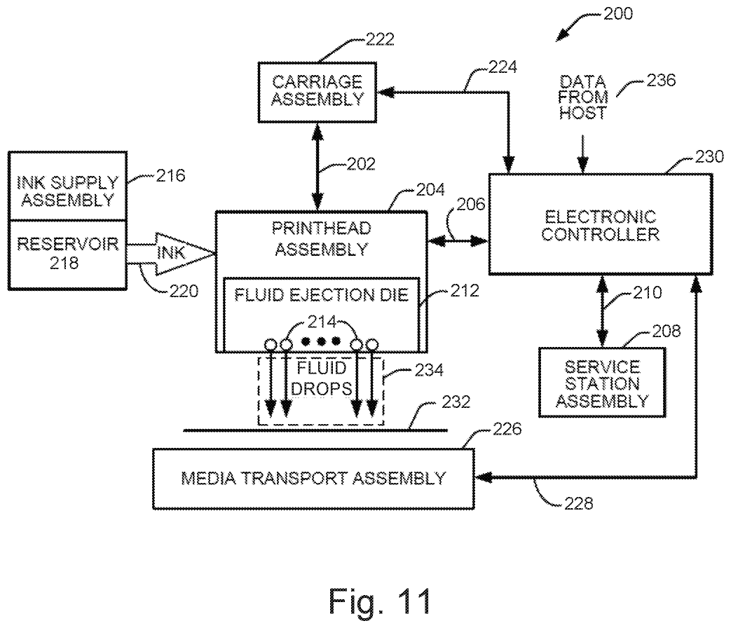

In one example, a minimum adjustment accumulation value is stored in a minimum accumulation register 108 and a maximum adjustment accumulation value is stored in a maximum accumulation register 110. In one example, the minimum and maximum adjustment accumulation values respectively define the number of quanta decrements and the number of quanta decrements that can be made to adjust the pulse width of a fire pulse as it propagates through the zones fluidic dies, such as through zones 22-1 to 22-n, for example. In example, the minimum and maximum adjustment accumulation values are provided by a system controller (e.g., electronic controller 230 of FIG. 11).

For each zone temperature, equality blocks 112 and 114 respectively compare the adjusted accumulation value from register 102 to the minimum and maximum adjusted accumulation values. The outputs of equality blocks 112 and 114 respectively pass through inverters 116 and 118 and respectively serve as second inputs to decrement and increment AND-gates 104 and 106. If the adjusted accumulation value from accumulation register 102 is equal to the minimum adjustment accumulation value from register 108 (meaning that the pulse width is at the minimum allowed pulse width and can no longer be decremented), equality block 112 outputs a logic high (e.g., “1”), which is inverted by inverter 116 to a logic low (e.g. “0”), which prevents decrement AND-gate 104 from decrementing the adjusted accumulation value in accumulation register 102. If the adjusted accumulation value from accumulation register 102 is not equal to the minimum adjusted accumulation value from register 108, equality block 112 outputs a logic low, which is inverted by inverter 116 to a logic high, which enables decrement AND-gate 104 to decrement the adjusted accumulation value in register 102 if the present adjusted accumulation value is greater than DVO (A>B).

If the adjusted accumulation value from accumulation register 102 is equal to the maximum adjustment accumulation value from register 110 (meaning that the pulse width is at the maximum allowed pulse width and can no longer be incremented), equality block 114 outputs a logic high (e.g., “1”), which is inverted by inverter 118 to a logic low (e.g. “0”), which prevents increment AND-gate 106 from incrementing the adjusted accumulation value in accumulation register 102. If the adjusted accumulation value from accumulation register 102 is not equal to the maximum adjusted accumulation value from register 110, equality block 114 outputs a logic low, which is inverted by inverter 118 to a logic high, which enables increment AND-gate 106 to increment the adjusted accumulation value in register 102 if the present adjusted accumulation value is less than DVO (A<B).

If both inputs to decrement AND-gate 104 are logic high, decrement AND-gate 104 outputs a logic high to the decrement input of adjustment accumulation register 102 to decrement the adjusted accumulation value, with the output a decrement-AND gate 104 also representing part of the zone adjustment signal to the adjustment register 62 of the corresponding zone 22. Similarly, if both inputs to increment AND-gate 104 are logic high, increment AND-gate 106 outputs a logic high to the increment input of adjustment accumulation register 102 to increment the adjusted accumulation value, with the output a increment-AND gate 104 also representing part of the zone adjustment signal to the adjustment register 62 of the corresponding zone 22.

Fire pulse control circuit 10 further includes a state machine 120 to coordinate the timing of the various components of input logic 12 and adjustment logic 14, including the loading of the zone adjustment value of zone adjustment signals to registers 62 of zones 22. For each set of zone temperatures, it is noted that state machine 120 resets adjustment accumulation register 102 to zero.

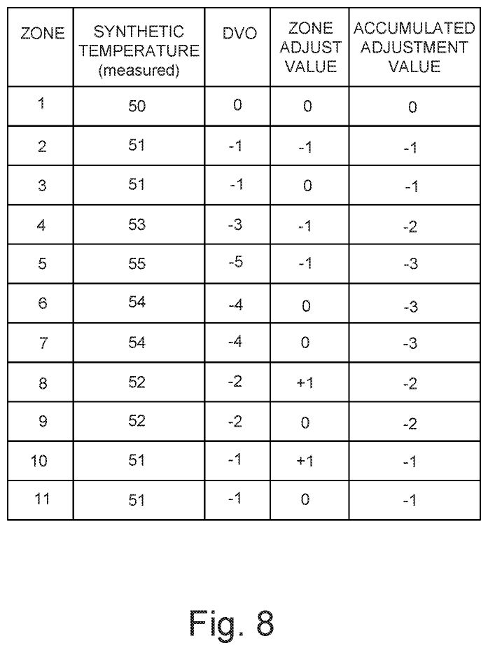

FIG. 8 is a table of example zone temperature values to illustrate the operation of pulse width control circuit 10 of FIG. 7, for a fluidic die having eleven zones, where the maximum and minimum adjustments to the pulse width are respectively limited to values of +3 and −3 quanta. The synthetic temperature values listed in the second column represent the synthetic temperatures of zones 1-11 after scaling and conversion by scaling block 90 and ADC 92.

For the first zone, the synthetic temperature of 50 is loaded into both registers 94 and 96 such that the value of DVO is zero. With the value of DVO at zero and the accumulated adjustment value in register 102 also equal to zero, the accumulated adjustment value in register 102 remains at zero (i.e., is neither incremented nor decremented). For zone 2, the value of DV0 is −1. Since −1 is less than the accumulated adjustment value, comparator block 100 outputs a value of 1 to the first input of decrement AND-gate 104. Since the accumulated adjustment value of 0 is not equal to the minimum adjustment value if register 108, equality block 112 outputs a zero, which is inverted to a value of 1 at the second input to decrement AND-gate 104. With both inputs to decrement AND-gate 104 having a value of 1, the output of decrement AND-gate has a value of 1, which decrements the accumulated adjustment value if register 102 to a value of −1, and results in the decrement and increments signals of the zone adjustment signal to respectively have values of “1” and “0”.

For zone 3, since the −1 value of DV0 is equal to the accumulated adjustment value of −1, the zone adjustment value is at “0” and the accumulated adjust value remains at −1 (i.e., is neither incremented nor decremented). For zone 4, since the −3 value of DV0 is less than the accumulated adjustment value of −1, the accumulated adjustment value is decremented to a value of −2 and the zone adjustment value is at −1 such that decrement signal has a value of 1 and the increment signal has a value of 0 (indicating that the pulse width is to be decremented by 1 quanta).

At zone 5, since the −5 value of DV0 is less than the accumulated adjustment value of −2, the accumulated adjustment value is decremented to a value of −3 and the zone adjustment value is at −1 such that decrement signal has a value of 1 and the increment signal has a value of 0 (indicating that the pulse width is to be decremented by 1 quanta). At zone 6, the DV0 value of −4 is less than the accumulated adjustment value of −3. However, because the accumulated adjustment value of −3 is equal to the minimum accumulated adjustment value of register 108, the output of equality block 112 has a value of 1, which results in a value of zero at the second input to decrement AND-gate 104 which blocks the accumulated adjustment value in register 102 from being decremented further and also results in a decrement zone signal value of 0. Thus, the accumulated adjustment value remains at −3 and the pulse width is not adjusted.

For zone 7, the DVO value is again at −4, thereby producing the same result as for zone 6. However, at zone 8, the DVO value of −2 is greater than the accumulated adjustment value of −3. Since the accumulated adjustment value of −3 is not equal to the maximum accumulated adjustment value of +3 in register 110, the inputs to increment AND-gate 106 both have logic values of 1, such that the accumulated adjustment value is incremented by +1 to a value of −2 and the increment zone adjustment signal has a value of 1 (indicated that the pulse width is to be incremented by 1 quanta). The above process is repeated for each of the remaining zones 9-11, with the results being as illustrated in the table of FIG. 8.

As can be seen by the example values of the table of FIG. 8, fire pulse control circuit 10 of FIG. 7 prevents the pulse width from being decremented or incremented by more than the allowed number of quanta adjustments loaded into minimum and maximum accumulated adjustment registers 110 and 108, thereby preventing the fire pulse from providing either too much or too little energy to the actuation devices 52 of the primitives 50 of the corresponding zones.

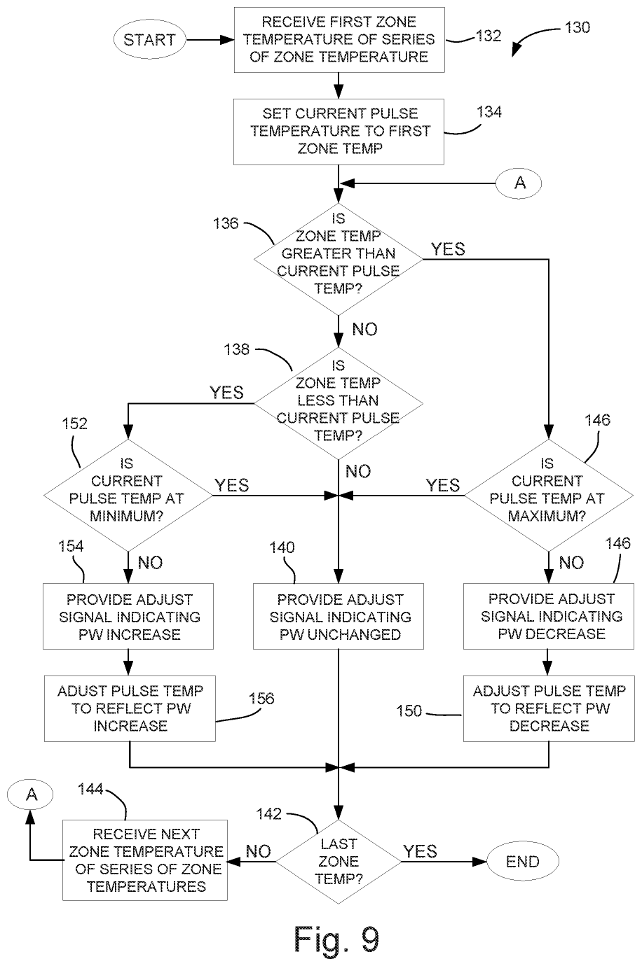

FIG. 9 is a flow diagram illustrating a method 130 of adjusting a fire pulse width for fluidic die, according to principles of the present disclosure. Method 130 begins at 132 with receiving a first zone temperature of a series of zone temperatures, where each zone temperature corresponds to a different zone of the fluidic die, with each zone having a corresponding fire pulse having a pulse width with a corresponding pulse temperature, the pulse width adjustable within pulse width adjustment range from a minimum width corresponding to a maximum pulse temperature and a maximum width corresponding to a minimum pulse temperature, such as fire pulse control circuit 10 of FIG. 2 receiving a series of zone temperatures from zones 22. At 134, method 130 includes setting the current pulse temperature to the pulse temperature corresponding to the pulse width of the first zone, which, in this case, is the measured zone temperature of zone 1, such as illustrated by fire pulse control circuit of FIG. 2 setting the current pulse temperature to the temperature of first zone 22-1, the pulse temperature as illustrated by the graph of FIG. 4.

At 136, method 130 queries whether the zone temperature is greater than the current pulse temperature. If the answer to the query at 136 is “no”, method 130 proceeds to 138. At 138, method 130 queries whether the zone temperature is less than the current pulse temperature. If the answer to the query at 138 is “no”, method 130 proceeds to 140, where a zone adjustment signal directing no change in the pulse width is provided, such as adjustment logic 14 of FIG. 7 providing a zone adjustment signal directing no change in the pulse width if the DVO value is equal to the accumulated adjustment value of register 102. Process 130 then proceeds to 142 where it is queried whether the zone temperature is the last zone temperature of the series of zone temperatures. If the answer to the query at 142 is “yes”, method 130 ends. If the answer to the query at 142 is “no”, method 130 proceeds to 144 where the next zone temperature of the series of zone temperatures is received, and the returns to 136.

If the answer to the query at 136 is “yes”, method 130 proceeds to 146, where it is queried whether the current pulse temperature is at the maximum pulse temperature. If the answer to the query at 146 is “yes”, method 130 proceeds to 140, such as illustrated by the accumulated adjustment value of register 102 of FIG. 7 being equal to the maximum accumulation value if register 110. If the answer to the query at 146 is “no”, method 130 proceeds to 148 where a zone adjustment signal directing a decrease in the fire pulse width is provided, such as fire pulse control circuit 10 of FIG. 7 providing a zone adjustment signal directing a decrement in the fire pulse width when the accumulated adjustment value of register 102 is greater than the DVO value and is not equal to the minimum accumulated value in register 108. Method 130 then proceeds to 150 where the current pulse temperature is updated to the pulse temperature corresponding to the decremented width of the fire pulse at 148 (i.e. the pulse temperature is increased), and then proceeds to 142.

If the answer to the query at 138 is “yes”, method 130 proceeds to 152, where it is queried whether the current pulse temperature is at the minimum pulse temperature. If the answer to the query at 152 is “yes”, method 130 proceeds to 140. If the answer to the query at 152 is “no”, method 130 proceeds to 154 where a zone adjustment signal directing an increase in the pulse width is provided, such as fire pulse control circuit 10 of FIG. 7 providing a zone adjustment signal directing an increment in the fire pulse width when the accumulated adjustment value of register 102 is less than the DVO value and is not equal to the maximum accumulated value in register 110. Method 130 then proceeds to 156 where the current pulse temperature is updated to the pulse temperature corresponding to the incremented width of the fire pulse at 154 (i.e. the pulse temperature is decreased), and then to 142.

It is noted that in one example, the increase and decrease in pulse width at 154 and 148 can be directed in quanta adjustments, and in other examples may be directed as continuous adjustments based on the pulse width versus temperature curve relationship as described by FIGS. 4 and 5.

FIG. 10 is a flow diagram describing a method 170 of controlling a fire pulse for a fluidic die, according to one example. At 172, method 170 includes receiving a series of zone temperatures, such as fire pulse control circuit 10 of FIG. 2 receiving a series of zone temperatures from thermal sensors 54 of fluidic die 20. In one example, each zone temperature corresponds to a different zone of the fluidic die, each zone receiving a corresponding fire pulse having a pulse width having a corresponding pulse temperature, the pulse width adjustable from a minimum width corresponding to a maximum pulse temperature, to a maximum pulse width corresponding to a minimum pulse temperature, such as illustrated by FIGS. 3-5.

At 174, method 170 includes, for each zone temperature, decreasing the fire pulse width of the corresponding zone if the zone temperature is greater than the pulse temperature, and the pulse temperature is less than the maximum pulse temperature (i.e., the current pulse width is greater than the minimum pulse width). At 176, method 170 includes, for each zone temperature, increasing the fire pulse width of the corresponding zone if the zone temperature is less than the pulse temperature, and the pulse temperature is greater than the minimum pulse temperature (i.e., the current pulse width is less than the maximum pulse width), such as described at FIG. 2 with regard to adjustment logic 14 of fire pulse control circuit 10.

FIG. 11 is a block diagram illustrating one example of a fluid ejection system 200. Fluid ejection system 200 includes a fluid ejection assembly, such as printhead assembly 204, and a fluid supply assembly, such as ink supply assembly 216. In the illustrated example, fluid ejection system 200 also includes a service station assembly 208, a carriage assembly 222, a print target transport assembly 226, where print media is an example of a 2D print target, and a bed of build material is an example of a 3D print target. Fluid ejection system 200 further includes an electronic controller 230, where electronic controller 230 may provide the Fire_in signal, as illustrated in FIG. 2, and the minimum and maximum accumulated adjustment values to registers 108 and 110 in FIG. 7. In one example, electronic controller may include all or portions of fire pulse control logic 10 as illustrated by FIGS. 1 and 7, for instance. While the following description provides examples of systems and assemblies for fluid handling with regard to ink, the disclosed systems and assemblies are also applicable to the handling of fluids other than ink.

Printhead assembly 204 includes printhead 212 which ejects drops of fluid (e.g., ink) through a plurality of orifices or nozzles 214, where printhead 212 may be implemented, in one example, as fluidic die 20. In one example, the drops are directed toward a medium, such as print media 232, so as to print onto print media 232. In one example, print media 232 includes any type of suitable sheet material such as paper, card stock, transparencies, Mylar, fabric, and the like, which are suitable for 2D printing, while print media 232 includes media such as a powder bed for 3D printing, or media for bioprinting and/or drug discovery testing, such as a reservoir or container. In one example, nozzles 214 are arranged in a column or array such that properly sequenced ejection of ink from nozzles 214 causes characters, symbols, and/or other graphics or images to be printed upon print media 232 as printhead assembly 204 and print media 232 are moved relative to each other.

Ink supply assembly 216 supplies ink to printhead assembly 204 and includes a reservoir 218 for storing ink. As such, in one example, ink flows from reservoir 218 to printhead assembly 204. In one example, printhead assembly 204 and ink supply assembly 216 are housed together in an inkjet or fluid-jet print cartridge or pen. In another example, ink supply assembly 216 is separate from printhead assembly 204 and supplies ink to printhead assembly 204 through an interface connection 220, such as a supply tube and/or valve.

Carriage assembly 222 positions printhead assembly 204 relative to print media transport assembly 226, and print media transport assembly 226 positions print media 232 relative to printhead assembly 204. Thus, a print zone 234 is defined adjacent to nozzles 214 in an area between printhead assembly 204 and print media 232. In one example, printhead assembly 204 is a scanning type printhead assembly such that carriage assembly 222 moves printhead assembly 204 relative to print media transport assembly 226. In another example, printhead assembly 204 is a non-scanning type printhead assembly such that carriage assembly 222 fixes printhead assembly 204 at a prescribed position relative to print media transport assembly 226.

Service station assembly 208 provides for spitting, wiping, capping, and/or priming of printhead assembly 204 to maintain the functionality of printhead assembly 204 and, more specifically, nozzles 214. For example, service station assembly 208 may include a rubber blade or wiper which is periodically passed over printhead assembly 204 to wipe and clean nozzles 214 of excess ink. In addition, service station assembly 208 may include a cap that covers printhead assembly 204 to protect nozzles 214 from drying out during periods of non-use. In addition, service station assembly 208 may include a spittoon into which printhead assembly 204 ejects ink during spits to ensure that reservoir 218 maintains an appropriate level of pressure and fluidity, and to ensure that nozzles 214 do not clog or weep. Functions of service station assembly 208 may include relative motion between service station assembly 208 and printhead assembly 204.

Electronic controller 230 communicates with printhead assembly 204 through a communication path 206, service station assembly 208 through a communication path 210, carriage assembly 222 through a communication path 224, and print media transport assembly 226 through a communication path 228. In one example, when printhead assembly 204 is mounted in carriage assembly 222, electronic controller 230 and printhead assembly 204 may communicate via carriage assembly 222 through a communication path 202. Electronic controller 230 may also communicate with ink supply assembly 216 such that, in one implementation, a new (or used) ink supply may be detected.

Electronic controller 230 receives data 236 from a host system, such as a computer, and may include memory for temporarily storing data 236. Data 236 may be sent to fluid ejection system 200 along an electronic, infrared, optical or other information transfer path. Data 236 represents, for example, a document and/or file to be printed. As such, data 236 forms a print job for fluid ejection system 200 and includes print job commands and/or command parameters.

In one example, electronic controller 230 provides control of printhead assembly 204 including timing control for ejection of ink drops from nozzles 214. As such, electronic controller 230 defines a pattern of ejected ink drops which form characters, symbols, and/or other graphics or images on print media 232. Timing control and, therefore, the pattern of ejected ink drops, is determined by the print job commands and/or command parameters. In one example, logic and drive circuitry forming a portion of electronic controller 230 is located on printhead assembly 204. In another example, logic and drive circuitry forming a portion of electronic controller 230 is located off printhead assembly 204. In another example, logic and drive circuitry forming a portion of electronic controller 230 is located off printhead assembly 204.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. A fire pulse control circuit for a fluidic die, comprising:
input logic to receive a series of zone temperatures, each zone temperature corresponding to a different zone of the fluidic die, each zone having a corresponding fire pulse having a width corresponding to a pulse temperature, the width adjustable from a minimum width corresponding to a maximum pulse temperature to a maximum width corresponding to a minimum pulse temperature; and
adjustment logic, for each zone temperature, to:
output a zone adjustment signal to direct a decrease of the fire pulse width of the corresponding zone if the zone temperature is greater than the pulse temperature and the pulse temperature is less than the maximum pulse temperature; and
output a zone adjustment signal to direct an increase of the fire pulse width of the corresponding zone if the zone temperature is less than the pulse temperature and the pulse temperature is greater than the minimum pulse temperature.

2. The fire pulse control circuit of claim 1, the adjust logic, for each zone temperature, to output a zone adjustment signal directing no change in the fire pulse width of the corresponding zone when:
the zone temperature is less than the pulse temperature and the pulse temperature is not greater than the minimum pulse temperature; or
the zone temperature is greater than the pulse temperature and the pulse temperature is not less than the maximum pulse temperature; or
the zone temperature is equal to the pulse temperature.

3. The fire pulse control circuit of claim 1, the zone adjustment signal comprising a zone adjustment value indicative of a time duration by which to adjust the fire pulse width.

4. The fire pulse control circuit of claim 3, the fire pulse width adjustable in fixed increments, each increment being a same time duration, the zone adjustment signal indicating the number of increments by which the fire pulse width is to be increased or decreased.

5. The fire pulse control circuit of claim 4, including:
a first memory element to receive and store a maximum number of increments by which the fire pulse width may be incremented; and
a second memory element to receive and store a maximum number of increments by which the fire pulse may be decremented.

6. The fire pulse control circuit of claim 3, the fire pulse width continuously adjustable from the minimum width to the maximum width, the zone adjustment signal indicating a time duration by which the fire pulse width is to be increased or decreased.

7. The fire pulse control circuit of claim 1, to adjust current pulse temperature to correspond to the adjusted fire pulse width.

8. The fire pulse control circuit of claim 1, the fire pulse control circuit disposed on the fluidic die.

9. A fluidic die including:
a plurality of zones, each zone including:
a fire pulse adjustment circuit to receive a fire pulse having a width a corresponding to a pulse temperature, the width adjustable from a minimum width corresponding to a maximum pulse temperature to a maximum width corresponding to a minimum pulse temperature; and
a temperature sensor to measure the zone temperature; and a fire pulse control circuit to:
receive a series of zone temperatures from the temperature sensors of the plurality of zones, each zone temperature corresponding to a different zone of the fluidic die; and
for each zone temperature, to:
output a zone adjustment signal to direct the fire pulse adjustment circuit of the corresponding zone to decrease the fire pulse if the zone temperature is greater than the pulse temperature and the pulse temperature is less than the maximum pulse temperature; and
output a zone adjustment signal to direct the fire pulse adjustment circuit of the corresponding zone to increase the fire pulse width if the zone temperature is less than the pulse temperature and the pulse temperature is greater than the minimum pulse temperature.

10. The fluidic die of claim 9, the fire pulse control circuit, for each zone temperature, to output a zone adjustment signal directing no change in the fire pulse width of the corresponding zone when:
the zone temperature is less than the pulse temperature and the pulse temperature is not greater than the minimum pulse temperature; or
the zone temperature is greater than the pulse temperature and the pulse temperature is not less than the maximum pulse temperature; or
the zone temperature is equal to the pulse temperature.

11. The fluidic die of claim 10, the zones arranged in series with the current pulse temperature of the fire pulse of each zone being equal to a pulse temperature of a pulse width adjusted fire pulse of the preceding zone, the current pulse temperature of the first zone of the series determined the zone temperature of the first zone.

12. The fluidic die of claim 10, including:
a first memory element to receive and store a value indicative of the maximum pulse temperature; and
a second memory element to receive and store a value indicative of the minimum pulse temperature.

13. The fluidic die of claim 12, the fire pulse width adjustable in fixed increments, each increment being a same time duration, each zone adjustment signal indicating a number of increments by which the fire pulse width is to be increased or decreased.

14. The fluidic die of claim 13, the value stored in the first memory being a maximum number of increments by which the fire pulse width may be incremented, and the value stored in the second memory being a maximum number of increments by which the fire pulse may be decremented.

15. A method of controlling a fire pulse for a fluidic die including:
receiving a series of zone temperatures, each zone temperature corresponding to a different zone of the fluidic die, each zone receiving an fire pulse having a width corresponding to a pulse temperature of the fire pulse, the width adjustable from a minimum width corresponding to a maximum pulse temperature to a maximum width corresponding to a minimum pulse temperature;
for each zone temperature, decreasing the width of the fire pulse of the corresponding zone if the zone temperature is greater than the pulse temperature and the pulse temperature is less than the maximum pulse temperature; and
for each zone temperature, increasing the fire pulse width of the corresponding zone if the zone temperature is less than the pulse temperature and the pulse temperature is greater than the minimum pulse temperature.
